(19) United States
(12) Patent Application Publication
(10) Pub. No.: US 2026/0319301 A1
(43) Pub. Date: Oct. 15, 2026

(54) LIQUID CRYSTAL DISPLAY DEVICE AND DISPLAY APPARATUS

(71) Applicant: SONY GROUP CORPORATION, Tokyo (JP)

(72) Inventors: Nariyasu SUGAWARA, Tokyo (JP); Tomoaki HONDA, Tokyo (JP)

(21) Appl. No.: 18/872,311

(22) PCT Filed: Jun. 5, 2023
(86) PCT No.: PCT/JP2023/020813

§ 371 Date: Apr. 24, 2026

(30) Foreign Application Priority Data
Jun. 15, 2022 (JP) 2022-096656

(51) Int. Cl. G02F 1/1362

(52) U.S. Cl. CPC G02F 1/136227; G02F 2201/123; G02F 2203/02

(57) ABSTRACT

A liquid crystal display device according to an embodiment of the present disclosure includes: a liquid crystal layer; a first substrate including a pixel circuit that drives the liquid crystal layer for each of pixels; a second substrate disposed to be opposed to the first substrate with the liquid crystal layer interposed therebetween; and multiple first electrodes that are provided on the first substrate for the respective pixels and each include one or more standing parts standing toward the liquid crystal layer, a predetermined voltage being applied to each of the multiple first electrodes by the pixel circuit.

### TECHNICAL FIELD

The present disclosure relates to a liquid crystal display device to be used as a phase modulator and to a display apparatus, for example.

### BACKGROUND ART

For example, PTL 1 discloses a liquid crystal display device that improves a reflectance by providing, above a drive electrode provided for each pixel with a light-reflective film and an insulating film interposed therebetween, a transparent electrically-conductive film (transparent pixel electrode) that is also provided for each pixel and is electrically coupled to the drive electrode through a via.

### CITATION LIST

### Patent Literature

PTL 1: International Publication No. WO2020/008765

### SUMMARY OF THE INVENTION

Incidentally, in a typical liquid crystal display device to be used as a phase modulator, a reflectance has a trade-off relationship with a phase modulation amount and a response speed, and compatibility is to be achieved between these characteristics.

It is desirable to provide a liquid crystal display device and a display apparatus that make it possible to amplify a phase modulation amount and improve a response speed while improving a reflectance.

A liquid crystal display device according to an embodiment of the present disclosure includes: a liquid crystal layer; a first substrate including a pixel circuit that drives the liquid crystal layer for each of pixels; a second substrate disposed to be opposed to the first substrate with the liquid crystal layer interposed therebetween; and multiple first electrodes that are provided on the first substrate for the respective pixels and each include one or more standing parts standing toward the liquid crystal layer, a predetermined voltage being applied to each of the multiple first electrodes by the pixel circuit.

A display apparatus according to an embodiment of the present disclosure includes the same components as those of the liquid crystal display device according to the embodiment described above.

In the liquid crystal display device according to the embodiment of the present disclosure and the display apparatus according to the embodiment of the present disclosure, the one or more standing parts standing toward the liquid crystal layer are provided on each of the multiple first electrodes that are provided for the respective pixels and to each of which the predetermined voltage is applied by the pixel circuit that drives the liquid crystal layer for each of the pixels. This increases an effective potential to be applied to the liquid crystal layer.

### BRIEF DESCRIPTION OF DRAWINGS

FIG. 1 is a cross-sectional schematic diagram illustrating a configuration of a liquid crystal display device according to an embodiment of the present disclosure.

FIG. 2 is a plane schematic diagram for describing a structure of multiple pixel electrodes of the liquid crystal display device illustrated in FIG. 1.

FIG. 3 is a characteristic diagram illustrating a relationship between a width of a standing part and a reflectance on a drive substrate side.

FIG. 4 is a schematic diagram illustrating an example of a method of removing unnecessary diffracted light.

FIG. 5 is a diagram illustrating another example of a method of removing unnecessary diffracted light (a correction system).

FIG. 6A is a schematic diagram illustrating an example of a method of manufacturing the liquid crystal display device illustrated in FIG. 1.

FIG. 6B is a schematic diagram illustrating a step subsequent to FIG. 6A.

FIG. 6C is a schematic diagram illustrating a step subsequent to FIG. 6B.

FIG. 6D is a schematic diagram illustrating a step subsequent to FIG. 6C.

FIG. 6E is a schematic diagram illustrating a step subsequent to FIG. 6D.

FIG. 6F is a schematic diagram illustrating a step subsequent to FIG. 6E.

FIG. 7 is a cross-sectional schematic diagram illustrating an example of a configuration of a typical liquid crystal display device.

FIG. 8 is a cross-sectional schematic diagram illustrating another example of a configuration of a typical liquid crystal display device.

FIG. 9 is a simulation diagram illustrating a relationship between a phase modulation amount and an application voltage of each of the liquid crystal display devices illustrated in FIGS. 1, 7, and 8.

FIG. 10 is a simulation diagram illustrating a relationship between the phase modulation amount and time of each of the liquid crystal display devices illustrated in FIGS. 1, 7, and 8.

FIG. 11 is a cross-sectional schematic diagram illustrating an example of a configuration of a liquid crystal display device according to Modification Example 1 of the present disclosure.

FIG. 12 is a plane schematic diagram illustrating a structure of a pixel electrode of the liquid crystal display device illustrated in FIG. 11.

FIG. 13 is a cross-sectional schematic diagram illustrating an example of a configuration of a liquid crystal display device according to Modification Example 2 of the present disclosure.

FIG. 14 is a plane schematic diagram illustrating a structure of a pixel electrode of the liquid crystal display device illustrated in FIG. 13.

FIG. 15 is a cross-sectional schematic diagram illustrating an example of a configuration of a liquid crystal display device according to Modification Example 3 of the present disclosure.

FIG. 16 is a plane schematic diagram illustrating a structure of a pixel electrode of the liquid crystal display device illustrated in FIG. 15.

FIG. 17A is a schematic diagram illustrating a method of manufacturing the liquid crystal display device according to Modification Example 4 of the present disclosure.

FIG. 17B is a schematic diagram illustrating a step subsequent to FIG. 17A.

FIG. 17C is a schematic diagram illustrating a step subsequent to FIG. 17B.

FIG. 17D is a schematic diagram illustrating a step subsequent to FIG. 17C.

FIG. 17E is a schematic diagram illustrating a step subsequent to FIG. 17D.

FIG. 18A is a schematic diagram illustrating a method of manufacturing the liquid crystal display device according to Modification Example 5 of the present disclosure.

FIG. 18B is a schematic diagram illustrating a step subsequent to FIG. 18A.

FIG. 18C is a schematic diagram illustrating a step subsequent to FIG. 18B.

FIG. 18D is a schematic diagram illustrating a step subsequent to FIG. 18C.

FIG. 18E is a schematic diagram illustrating a step subsequent to FIG. 18D.

FIG. 18F is a schematic diagram illustrating a step subsequent to FIG. 18E.

FIG. 18G is a schematic diagram illustrating a step subsequent to FIG. 18F.

### MODES FOR CARRYING OUT THE INVENTION

In the following, description is given in detail of embodiments of the present technology with reference to the drawings. The following description is merely a specific example of the present disclosure, and the present disclosure should not be limited to the following aspects. Moreover, the present disclosure is not limited to arrangements, dimensions, dimensional ratios, and the like of each component illustrated in the drawings. It is to be noted that the description is given in the following order.
1. Embodiment (An example of a liquid crystal display device that includes a pixel electrode including a standing part standing toward a liquid crystal layer)
   1-1. Configuration of Liquid Crystal Display Device
   1-2. Method of Manufacturing Liquid Crystal Display Device
   1-3. Action and Effects
2. Modification Examples
   2-1. Modification Example 1 (Another example of a configuration of the pixel electrode)
   2-2. Modification Example 2 (Another example of a configuration of the pixel electrode)
   2-3. Modification Example 3 (Another example of a configuration of the pixel electrode)
   2-4. Modification Example 4 (Another example of a method of manufacturing the pixel electrode)
   2-5. Modification Example 5 (Another example of a method of manufacturing the pixel electrode)
3. Application Examples

### 1. EMBODIMENT

### 1-1. Configuration of Liquid Crystal Display Device

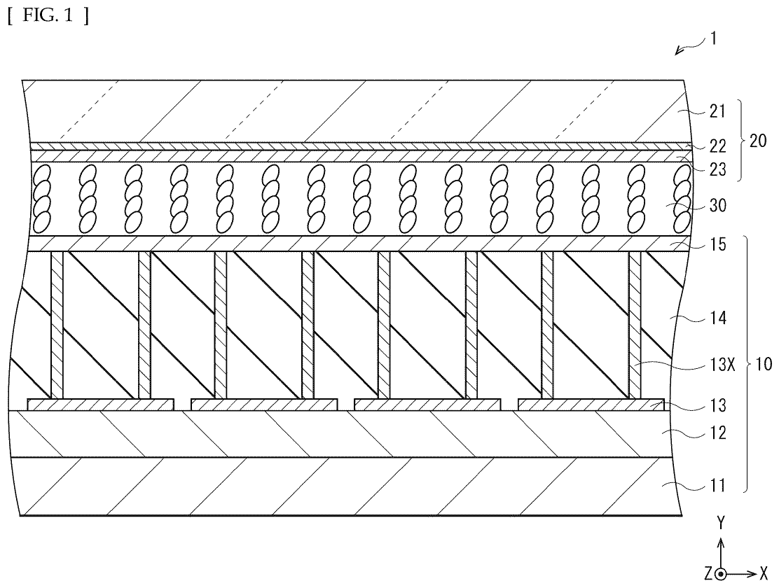

FIG. 1 illustrates an example of a schematic cross-sectional configuration of a liquid crystal display device (liquid crystal display device 1) according to an embodiment of the present disclosure. The liquid crystal display device 1 is to be used as a phase modulator of a display apparatus. The liquid crystal display device 1 includes a liquid crystal layer 30 between a drive substrate 10 and a counter substrate 20 disposed to be opposed to each other. The drive substrate 10 includes multiple pixel electrodes 13 that are provided for respective pixels P and to each of which a predetermined voltage is applied by a pixel circuit. The multiple pixel electrodes 13 are each provided with a standing part 13X standing toward the liquid crystal layer 30.

The drive substrate 10 includes, for example, a substrate 11 including silicon (Si), a pixel circuit layer 12, the multiple pixel electrodes 13, a high reflection coating 14, and an alignment film 15. The pixel circuit layer 12, the multiple pixel electrodes 13, the high reflection coating 14, and the alignment film 15 are provided in this order on a surface of the substrate 11 on the liquid crystal layer 30 side.

The pixel circuit layer 12 is provided on the substrate 11 and incudes, for example, the pixel circuit that drives the liquid crystal layer 30 for each of the pixels P. The pixel circuit includes a transistor Tr that writes a signal voltage into the pixel P by applying a voltage to each of the multiple pixel electrodes 13, and a storage capacitor Cs that holds the voltage written in the pixel P.

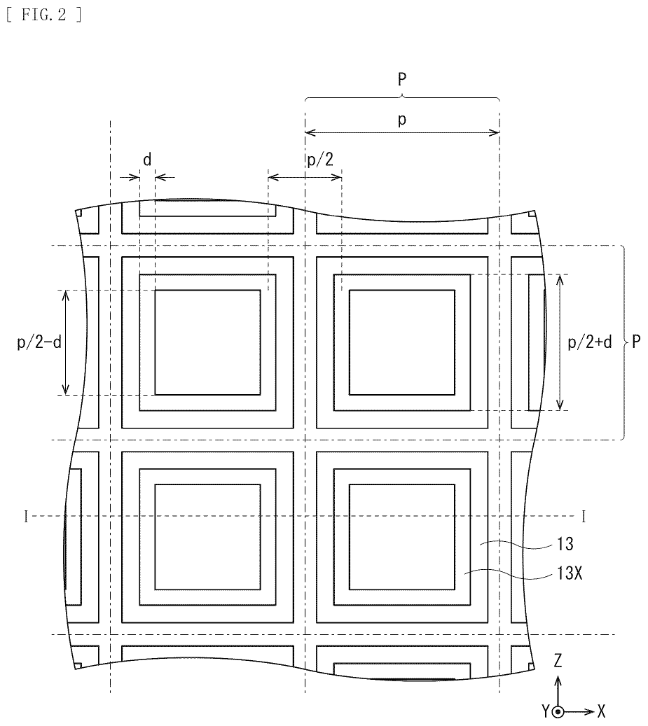

FIG. 2 schematically illustrates an example of a planar configuration of the multiple pixel electrodes 13 of the liquid crystal display device 1 illustrated in FIG. 1. FIG. 1 illustrates a cross section corresponding to a line I-I illustrated in FIG. 2. The multiple pixel electrodes 13 correspond to a specific example of “multiple first electrodes” of the present disclosure. The multiple pixel electrodes 13 are provided for the respective pixels P that are two-dimensionally arranged in a matrix. The multiple pixel electrodes 13 each have a substantially rectangular shape as illustrated in FIG. 2, for example. On a surface of each of the multiple pixel electrodes 13 on the liquid crystal layer 30 side is provided the standing part 13X standing toward the liquid crystal layer 30 and, for example, penetrating the high reflection coating 14. The standing part 13X has, for example, a partition structure that is continuously formed along an outer shape of the pixel electrode 13.

Note that the standing part 13X does not necessarily have to penetrate the high reflection coating 14. An end face of the standing part 13C may be covered by a portion of the high reflection coating 14.

The pixel electrode 13 includes, for example, a metal material having a light-reflecting property and mainly including a low-resistance metal, such as aluminum (Al), titanium (Ti), copper (Cu), silicon (Si), silver (Ag), or an alloy thereof (e.g., an Al—Cu-based alloy or an Al—Si alloy). The standing part 13X includes, for example, an electrically-conductive material having a light-reflecting property with respect to light of a wavelength range for use (e.g., visible light). Specific examples include metal materials such as aluminum (Al), copper (Cu), gold (Au), silver (Ag), and tungsten (W). In addition, the standing part 13X may be formed using, for example, an electrically-conductive material having a light-transmitting property, such as indium tin oxide (ITO), indium zinc oxide (IZO), or tin oxide (SnO₂).

Thus widening the choice of materials makes it is possible to optimize design in terms of optical characteristics such as a reflectance, ease of fabrication, and flatness. It is also possible to achieve a high power by additionally taking light absorption and heat resistance of the material into consideration. For example, forming the standing part 13X using aluminum (Al) makes it possible to obtain a favorable reflectance in a wide wavelength band. Forming the standing part 13X using copper (Cu) makes it possible to obtain a high flatness. Forming the standing part 13X using tungsten W makes it possible to form the standing part 13X by a process similar to that for a via that couples the pixel circuit and the pixel electrode 13 to each other. Forming the standing part 13X using silver (Ag) makes it possible to obtain a high reflectance in a long wavelength range of equal to or greater than 500 nm. On the other hand, forming the standing part 13X using ITO, which is a transparent electrically-conductive material, makes light absorption small and makes it possible to obtain a high light resistance. Forming the standing part 13X using IZO improves a transmittance and thus makes it possible to further improve the light resistance.

The high reflection coating 14 serves to achieve a high reflectance of the liquid crystal display device 1. The high reflection coating 14 is configured using, for example, a dielectric film including one or more layers. A dielectric film (dielectric multilayer film) including multiple layers is a stacked film in which a film (low refractive index film) including a low refractive material and a film (high refractive index film) including a high refractive index material are alternately stacked. It is possible to achieve a reflectance close to 100% in theory by controlling a phase of the reflectance caused at each interface by a film thickness (optical path length).

Examples of a material included in the low refractive index film include silicon oxide (SiO₂) and magnesium fluoride (MgF₂). Examples of a material included in the high refractive index film include titanium oxide (TiO₂), tantalum oxide (TaO₂), aluminum oxide (Al₂O₃), zirconium oxide (ZrO₂), and hafnium oxide (HfO₂). The high reflection coating 14 has a thickness dependent on the reflectance to be achieved, a target wavelength for which the reflectance is to be amplified, and a refractive index of the reflective film. For example, at a wavelength of 1064 nm, the high reflection coating 14 may have a total film thickness of about 3 μm in a case where eight pairs of the low refractive index film and the high refractive index film are stacked in order to achieve a reflectance close to 100%.

Widening the choice of materials makes it is possible to form the high reflection coating 14 having high light resistance and heat resistance with respect to light of the wavelength range for use (e.g., visible light). Thus, it is possible to make the liquid crystal display device 1 adaptable to a high-power laser. It is also possible to allow the liquid crystal display device 1 to withstand a pulsed laser such as a femtosecond laser that has a small average power but exhibits a very large instantaneous light intensity. This makes it possible to use the liquid crystal display device 1 in fine processing applications such as a two-photon absorption 3D printer.

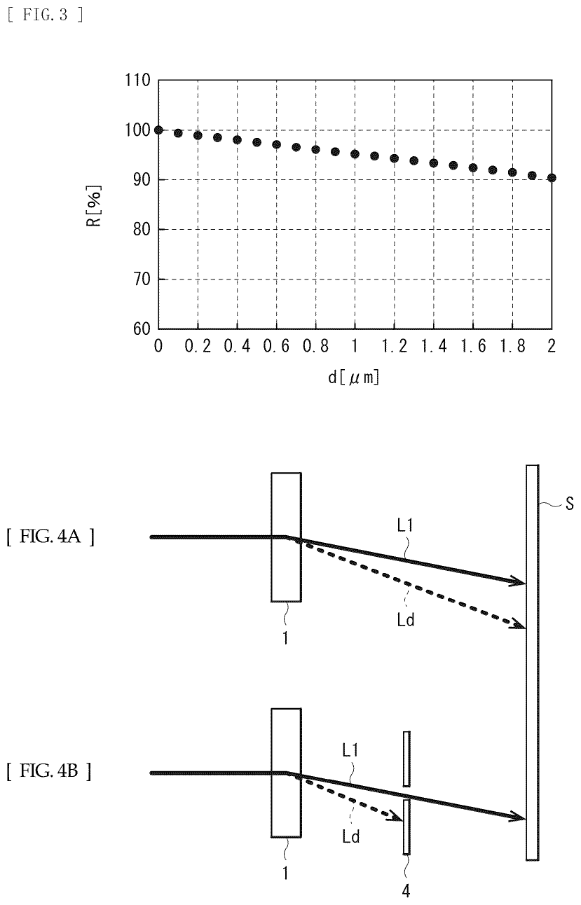

FIG. 3 is a characteristic diagram illustrating a relationship between a width of the standing part 13X and a reflectance on the drive substrate 10 side. With respect to visible light, the dielectric multilayer film (the high reflection coating 14) has a reflectance of 100% in theory and, for example, aluminum (Al) has a reflectance of about 90%. An area of the standing part 13X in plan view may be geometrically calculated, for example, as represented by the following expression (1). For example, in a case where a pixel pitch (p) is 4.2 μm and the width (d) of the standing part 13X is 0.3 μm, an area (Spix) of the pixel P is 17.64 μm², the area of the standing part 13X is 2.52 μm², and an area of the high reflection coating 14 in the pixel P is 15.12 μm². Thus, a reflectance of 98.6% is expectable by calculating the reflectance from an area ratio between the parts. Even if the standing part 13X is thickened to 1 μm, the reflectance is expected to be 95.24%, indicating a certain effect.

$$\begin{matrix}[ Formula 1 ] & \\ \begin{matrix}{S}_{pix} = {( \frac{p}{2} + d )}^{2} - {( \frac{p}{2} - d )}^{2} \\ = 2 pd\end{matrix} & ( 1 )\end{matrix}$$

The alignment film 15 performs an alignment control of the liquid crystal layer 30. The alignment film 15 includes, for example, an inorganic material such as silicon oxide (SiO₂), diamond-like carbon, or aluminum oxide (Al₂O₃). In addition, the alignment film 15 may include an organic material such as polyimide (PI) or polyimide (PVA). The alignment film 15 has a thickness of, for example, equal to or more than 50 nm and equal to or less than 500 nm. The alignment film 15 may be formed by, for example, a vapor deposition method, a rubbing method, or a photoalignment method.

The counter substrate 20 includes, for example, a substrate 21 having a light-transmitting property, a counter electrode 22, and an alignment film 23. The counter electrode 22 and the alignment film 23 are provided in this order on a surface of the substrate 21 on the liquid crystal layer 30 side.

The counter electrode 22 is provided, for example, as a common electrode for all the pixels P. The counter electrode 22 includes, for example, an electrically-conductive material having a light-transmitting property. Examples of the electrically-conductive material having a light-transmitting property include indium tin oxide (ITO), indium zinc oxide (IZO), zinc oxide (ZnO), and indium-gallium-zinc-containing oxide (IGZO).

The alignment film 23 performs an alignment control of the liquid crystal layer 30. The alignment film 23 includes, for example, an inorganic material such as silicon oxide (SiO₂), diamond-like carbon, or aluminum oxide (Al₂O₃). In addition, the alignment film 23 may include an organic material such as polyimide (PI) or polyimide (PVA). The alignment film 23 has a thickness of, for example, equal to or more than 50 nm and equal to or less than 500 nm. The alignment film 15 may be formed by, for example, a vapor deposition method, a rubbing method, or a photoalignment method.

The liquid crystal layer 30 includes a liquid crystal to be driven in, for example, a VA (Vertical Alignment) mode, a TN (Twisted Nematic) mode, an ECB (Electrically controlled birefringence) mode, an FFS (Fringe Field Switching) mode, or an IPS (In Plane Switching) mode. The liquid crystal layer 30 is sealed by a thermosetting or UV curable sealant that bonds the drive substrate 10 and the counter substrate 20 to each other and is, for example, commercially available for liquid crystal displays. After the drive substrate 10 and the counter substrate 20 are bonded to each other by the sealant, the liquid crystal is injected into the liquid crystal layer 30, and the liquid crystal layer 30 is sealed by, for example, the UV curable sealant. Alternatively, the liquid crystal layer 30 may be fabricated by, for example, an ODF (One Drop Fill) process. An image voltage is supplied to the liquid crystal layer 30 by the multiple pixel electrodes 13 and the counter electrode 22.

FIG. 4 schematically illustrates an example of a method of removing unnecessary diffracted light. As illustrated in (A) of FIG. 4, emitted light that is emitted from the liquid crystal display device 1 includes, in addition to +1-order diffracted light L1, unnecessary diffracted light Ld due to a spatial phase distribution caused by the provision of the standing part 13X. Therefore, for example, a spatial filter 4 may be disposed on a light emission side of the liquid crystal display device 1, as illustrated in (B) of FIG. 4. A cutting position of the spatial filter 4 is disposed at a position of wide-angle unnecessary diffracted light caused by the standing part 13X, as illustrated in (B) of FIG. 4. Thus removing the unnecessary diffracted light caused by the provision of the standing part 13X makes it possible to improve quality of a reproduced image or prevent a malfunction of the entire system due to unnecessary light.

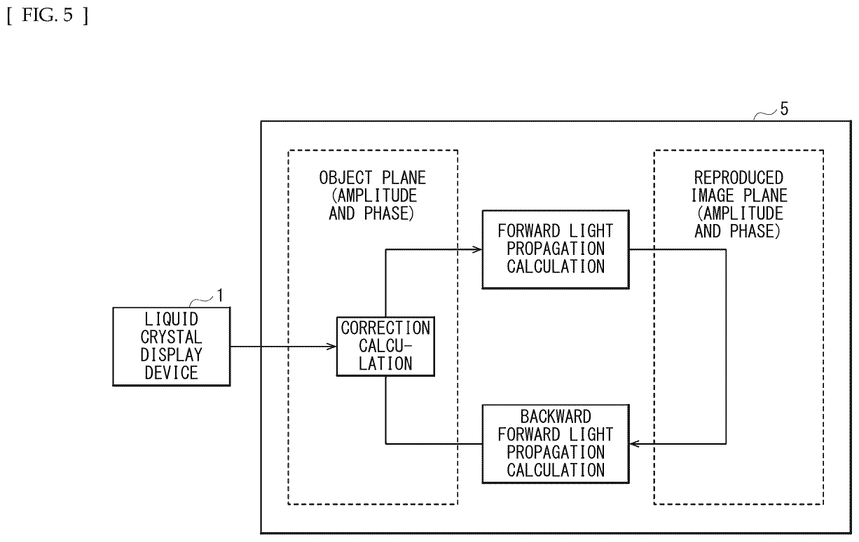

FIG. 5 illustrates another example of a method of removing unnecessary diffracted light (a correction system 5). The display apparatus including the liquid crystal display device 1 may be provided with a correction processing function (the correction system 5) that corrects the spatial phase distribution caused by the provision of the standing part 13X. As illustrated in FIG. 5, the correction system 5 is implementable by incorporating the spatial phase distribution peculiar to the structure of the standing part 13X that is formed, into an iteration of performing light propagation calculation such as an angular spectrum method or a GS (Gerchgerg-Saxton) method for deriving a CGH (Computer Generated Hologram) pattern to be displayed. Thus correcting the spatial phase distribution peculiar to the structure of the standing part 13X by signal processing makes it possible to make the phase distribution close to an ideal phase distribution. This reduces the unnecessary diffracted light and increases light utilization efficiency.

### 1-2. Method of Manufacturing Liquid Crystal Display Device

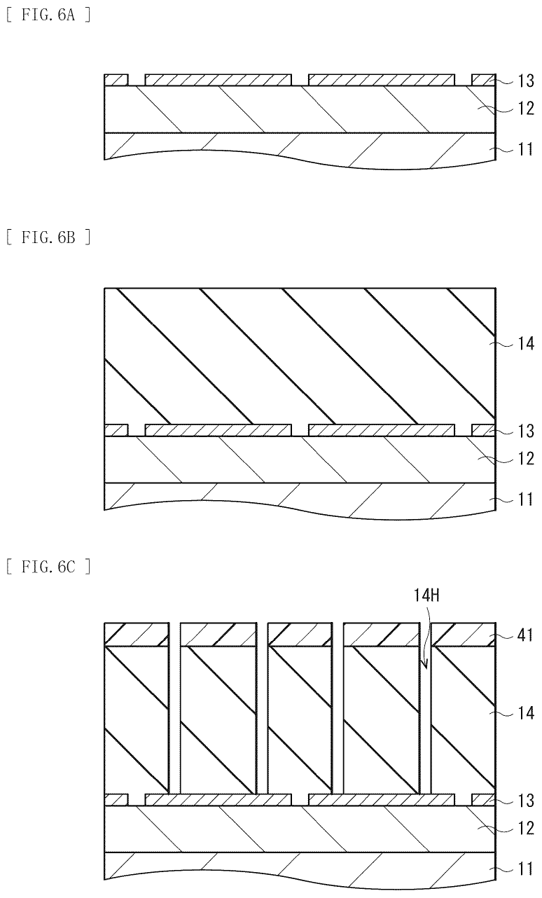

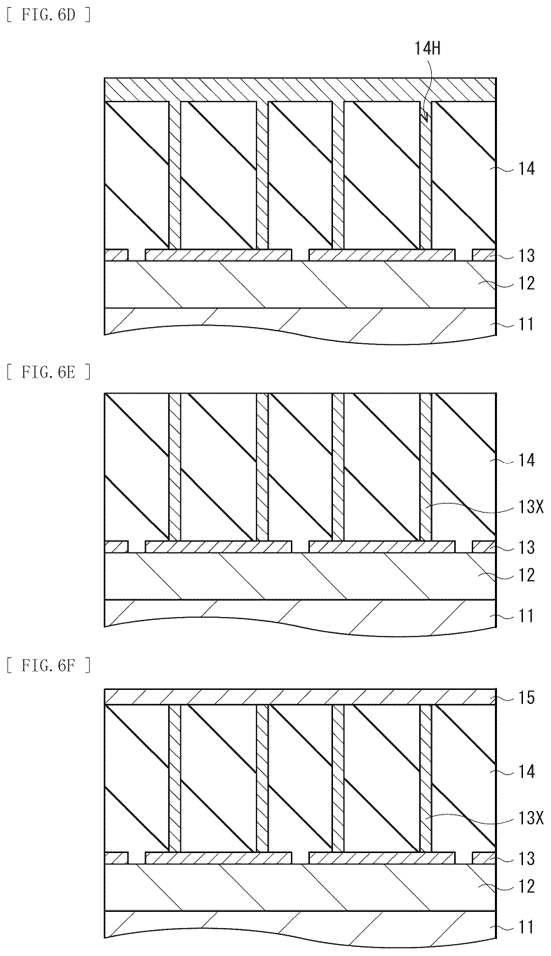

The liquid crystal display device 1 of the present embodiment may be manufactured as follows, for example. FIGS. 6A to 6F schematically illustrate an example of a method of manufacturing the liquid crystal display device 1.

First, after forming the pixel circuit layer 12 on the substrate 11, as illustrated in FIG. 6A, a metal film is formed by, for example, a chemical vapor deposition (CVD) method, and is thereafter processed by a lithography technique and dry processing (or wet processing) to form the multiple pixel electrodes 13 for the respective pixels P. Next, as illustrated in FIG. 6B, the low refractive index film and the high refractive index film are formed alternately on the pixel circuit layer 12 to cover the multiple pixel electrodes 13 by, for example, a vapor deposition method, to thereby form the high reflection coating 14 including the dielectric multilayer film.

Subsequently, as illustrated in FIG. 6C, a resist film 41 is formed in a pattern on the high reflection coating 14 by a lithography technique, and thereafter an opening 14H is formed to penetrate the high reflection coating 14 to the pixel electrode 13 by dry processing. Next, as illustrated in FIG. 6D, an electrically-conductive film is embedded in the opening 14H by, for example, a CVD method or an atomic layer deposition (ALD) method.

Subsequently, as illustrated in FIG. 6E, the electrically-conductive film formed on the high reflection coating 14 is removed by, for example, chemical polishing (CMP) to form the standing part 13X. Next, as illustrated in FIG. 6F, the alignment film 15 is formed on the high reflection coating 14 by, for example, a CVD method. Thus, the drive substrate 10 is completed.

Note that a passivation film may be formed after the standing part 13X is formed. This improves surface flatness of the high reflection coating 14.

Subsequently, the counter electrode 22 and the alignment film 23 are formed on one surface of the substrate 21 by a method similar to that described above. Thus, the counter substrate 20 is completed.

Thereafter, the drive substrate 10 and the counter substrate 20 are bonded to each other with a gap therebetween, and thereafter the liquid crystal is injected between the drive substrate 10 and the counter substrate 20 to form the liquid crystal layer 30. As a result, the liquid crystal display device 1 illustrated in FIG. 1 is completed.

### 1-3. Action and Effects

In the liquid crystal display device 1 of the present embodiment, the standing part 13X standing toward the liquid crystal layer 30 and having, for example, the partition structure is provided on each of the pixel electrodes 13 that are provided for the respective pixels P and to each of which the predetermined voltage is applied by the pixel circuit that drives the liquid crystal layer 30 for each of the pixels P. This increases an effective potential to be applied to the liquid crystal layer 30. This will be described below.

A spatial light phase modulator (Spatial Light Modulator: SLM) has been developed as a device that freely controls the phase of light. SLMs include a DMD (Digital mirror device) system using a piezoelectric effect, a MRAM (Magnetoresistive Random Access Memory) system using a magneto-optical effect, and a LCOS (Liquid Crystal on Silicon) system using an electro-optical effect produced by a liquid crystal. Among them, the LCOS-SLM system has attracted attention as the most promising system at present, and has been developed and researched.

The LCOS system controls the phase of light by changing the optical path length of each pixel sensed by incident light, by applying a voltage to a liquid crystal layer including a liquid crystal material having optical anisotropy and dielectric anisotropy. For example, in a LCOS-SLM using a liquid crystal (negative liquid crystal) with negative dielectric anisotropy, liquid crystal molecules of the pixel to which the voltage is applied are aligned substantially in a horizontal direction of a substrate, whereas liquid crystal molecules of the pixel to which the voltage is not applied are aligned in a direction orthogonal to the substrate. Thus, the optical path length is larger in the pixel to which the voltage is applied. This generates any spatial phase distribution, allowing for expression of a function of condensing or deflecting light.

It is desired to improve the reflectance of a pixel electrode to achieve high light utilization efficiency (=reflectance×diffraction efficiency). In general, aluminum (Al) is often used as the pixel electrode of a reflective LCOS. The reflectance of aluminum (Al) in the visible range is about 90%. In addition, a groove (inter-pixel gap) is provided for each pixel to allow for independent voltage application for each pixel. For example, assuming that the pixel pitch is 4.2 μm and the inter-pixel gap is 0.2 μm, an aperture ratio is 90.7%. Thus, a reflectance R in that case is expressed by the following expression (2), and reflectance of pixel electrode×aperture ratio is 81.6%. This indicates a loss of light of nearly 20%.

$$\begin{matrix}Formula 2 ] & \\ R = {R}_{Alm} \times \frac{{d}^{2}}{{p}^{2}} & ( 2 )\end{matrix}$$

(R: reflectance, R_{Alm}: reflectance of aluminum, d: width of pixel electrode, p: pixel pitch)

A dielectric multilayer film is generally used to achieve a high reflectance of the reflective LCOS. As described above, the dielectric multilayer film is a stacked film in which a low refractive index film and a high refractive index film are alternately stacked, and it is possible to achieve a reflectance close to 100% in theory by controlling the phase of the reflectance caused at each interface by the film thickness (optical path length). The dielectric multilayer film is actually used in commercially available LCOS-SLMs, and some devices achieve a reflectance exceeding 95%, depending on the aperture ratio.

In addition, the dielectric multilayer film plays a large role in terms of improving the light resistance with respect to a high-power laser. Aluminum (Al) generally used for the reflective LCOS exhibits absorption of nearly 10% in the visible light range as described above. Thus, incidence of a high-power laser on a level of several tens of watts, which is used in laser processing or the like, causes the device to be damaged by ablation due to light absorption. In techniques for preventing this, such as a mirror for high power, the dielectric multilayer film is widely used to suppress the absorption by the device and improve the reflectance.

Thin-film calculation software (Essential Macleod) was actually used, with the wavelength of 1064 nm set as a target, to optimize the design of the dielectric multilayer film in which the low refractive index film including SiO₂ (n=1.45) and the high refractive index film including UV-SiN (n=1.86) were alternately stacked. It was thus confirmed that a very high reflectance of 99.8% was exhibited at the wavelength of 1064 nm. Note that a layer physical film thickness of the dielectric multilayer film in this case was 3071 nm, being very large with respect to the film thickness of a typical alignment film.

Therefore, it is easy to imagine that applying the dielectric multilayer film to the reflective LCOS results in a decrease in the effective potential to be applied to the liquid crystal layer due to a voltage drop caused in the dielectric multilayer film as a side effect. As a result of the decrease in the effective potential, a rotational angle of the liquid crystal molecule decreases as compared with a case without a dielectric multilayer film, causing a decrease in a phase modulation amount. In addition, a response speed of the liquid crystal decreases. The former may be addressed by increasing a thickness of the liquid crystal layer to make the phase modulation amount equivalent to that in the case without a dielectric multilayer film structure. However, this makes the response speed even slower. It is generally well known that the response speed of the liquid crystal layer becomes slower in proportion to the square of the thickness (d) of the liquid crystal layer, as is apparent from theoretical expressions of the response speed represented by the following expressions (3) and (4).

$$\begin{matrix}[ Formula 3 ] & \\ {τ}_{rise} ∝ \frac{{γ}_{1} {d}^{2}}{{ε}_{0} \vert Δε \vert ( {V}^{2} - {V}_{th}^{2} )} & ( 3 )\end{matrix}$$

$${τ}_{fall} ∝ \frac{{γ}_{1} {d}^{2}}{{ε}_{0} \vert Δε \vert {V}_{th}^{2}} \qquad ( 4 )$$

(γ: rotational viscosity, Δε: dielectric anisotropy, d: thickness of liquid crystal layer, V: application voltage, Vₜₕ: threshold voltage)

The above indicates that, in a typical LCOS-SLM, the reflectance has a trade-off relationship with the phase modulation amount and the response speed.

In contrast, in the present embodiment, the standing part 13X standing toward the liquid crystal layer 30 and having the partition structure is provided on each of the multiple pixel electrodes 13 provided for the respective pixels P.

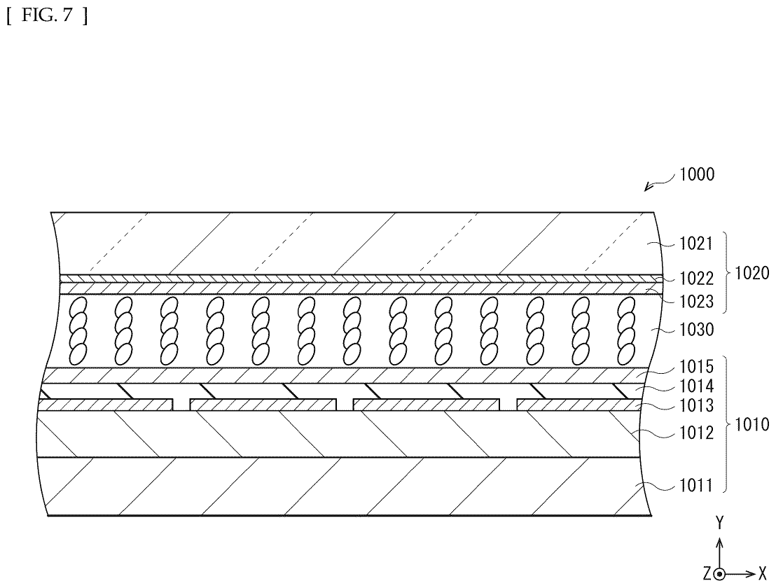

FIG. 7 illustrates an example of a schematic cross-sectional configuration of a typical liquid crystal display device 1000 including a surface-flattening insulating film 1014 between multiple pixel electrodes 1013 and an alignment film 1015. The liquid crystal display device 1000 includes a liquid crystal layer 1030 between a drive substrate 1010 and a counter substrate 1020. The drive substrate 1010 includes a pixel circuit layer 1012, the multiple pixel electrodes 1013, the insulating film 1014, and the alignment film 1015 that are stacked in this order on a substrate 1011. The counter substrate 1020 includes a counter electrode 1022 and an alignment film 1023 that are provided on one surface of a substrate 1021.

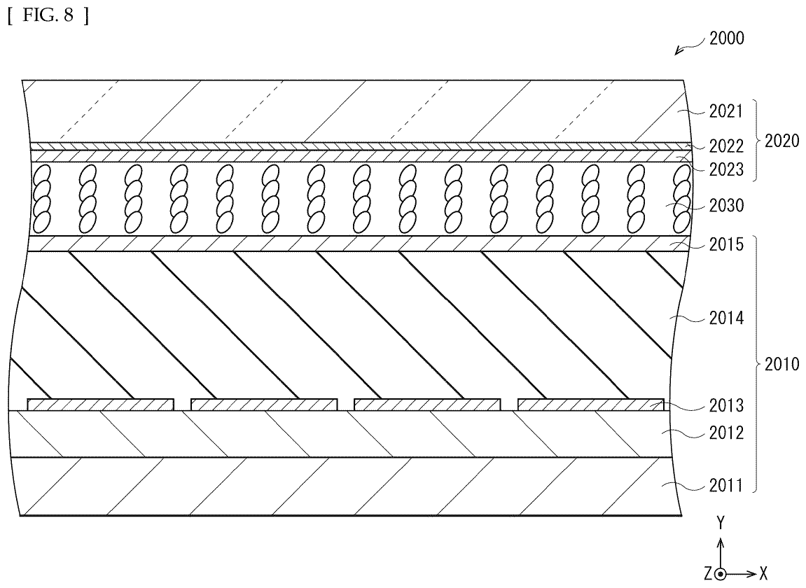

FIG. 8 illustrates an example of a schematic cross-sectional configuration of a typical liquid crystal display device 2000 including a high reflection coating 2014 including a dielectric multilayer film between multiple pixel electrodes 2013 and an alignment film 2015. The liquid crystal display device 2000 includes a liquid crystal layer 2030 between a drive substrate 2010 and a counter substrate 2020. The drive substrate 2010 includes a pixel circuit layer 2012, the multiple pixel electrodes 2013 without standing parts, the high reflection coating 2014, and the alignment film 2015 that are stacked in this order on a substrate 2011. The counter substrate 2020 includes a counter electrode 2022 and an alignment film 2023 that are provided on one surface of a substrate 2021.

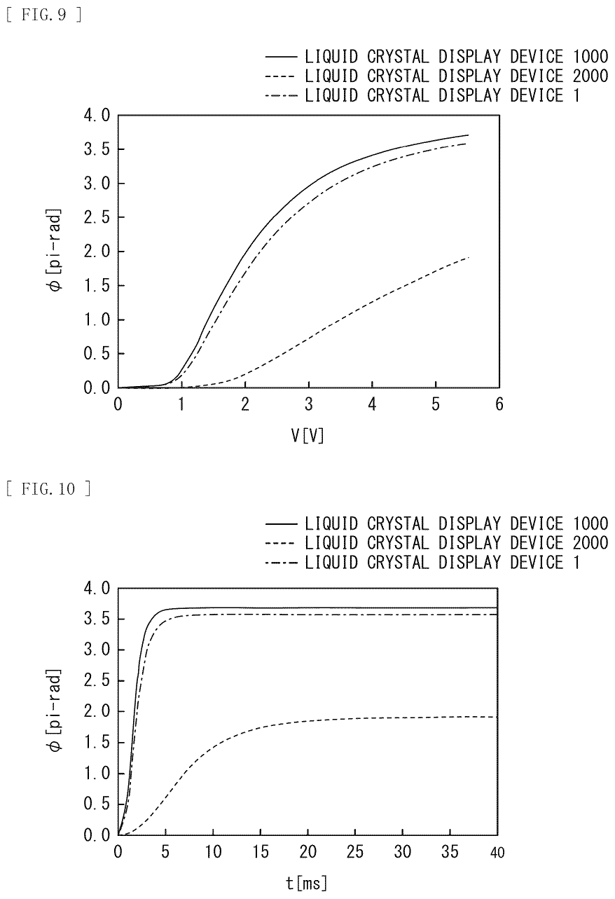

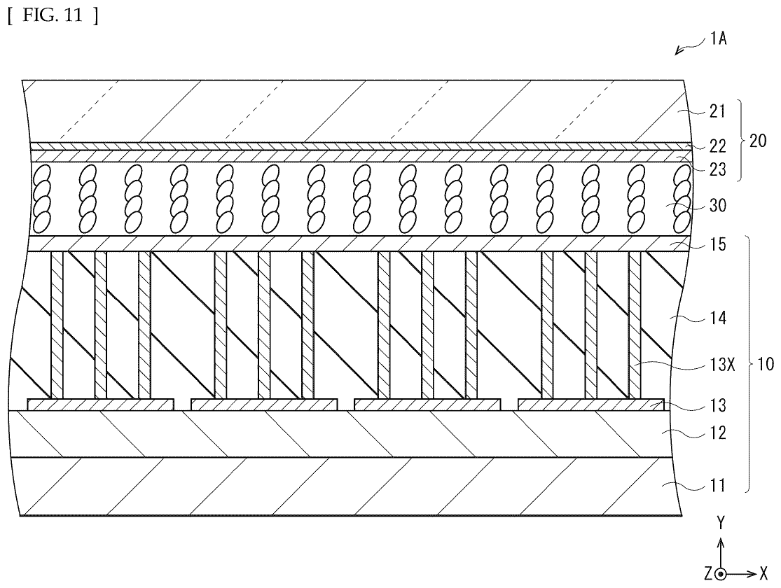

FIG. 9 illustrates a result of simulating, using a liquid crystal alignment simulator (LCD Master), a relationship between the phase modulation amount and the application voltage of each of the liquid crystal display devices 1, 1000, and 2000 illustrated in FIGS. 1, 7, and 8. FIG. 10 illustrates a result of simulating, using the liquid crystal alignment simulator (LCD Master), a relationship between the phase modulation amount and time of each of the liquid crystal display devices 1, 1000, and 2000 illustrated in FIGS. 1, 7, and 8. Table 1 summarizes relative values of the reflectance (FIG. 3), the phase modulation amount (FIG. 9), and the response speed (FIG. 10) in the liquid crystal display devices 1, 1000, and 2000 illustrated in FIGS. 1, 7 and 8, using the values of the liquid crystal display device 1000 as reference values (1.00). Preconditions for numerical calculation were as follows.

### (Preconditions for Numerical Calculation)

Wavelength: 550 nm
Width of standing part: 0.3 μm
Pixel pitch: 4.2 μm
Response speed: phase modulation amount of 10% to 90%

TABLE 1

| | Liquid crystal | Liquid crystal | Liquid crystal |
|---|---|---|---|
| | display device | display device | display device |
| | 1000 | 2000 | 1 |
| Reflectance [%] | 1.00 | 1.11 | 1.10 |
| Phase modulation | 1.00 | 0.52 | 0.97 |
| amount [pi-rad] | | | |
| Response speed | 1.00 | 5.00 | 1.67 |
| [ms] | | | |

Regarding the reflectance, it was confirmed that the liquid crystal display device 1 including the standing part 13X penetrating the high reflection coating 14 exhibited a reflectance equivalent to that of the liquid crystal display device 2000 provided with no standing part and including the high reflection coating 2014 including the dielectric multilayer film. Regarding the phase modulation amount, it was confirmed that the liquid crystal display device 1 including the standing part 13X penetrating the high reflection coating 14 exhibited a maximum phase modulation amount equivalent to that of the liquid crystal display device 1000 without a dielectric film. Also regarding the response speed, it was confirmed that the liquid crystal display device 1 including the standing part 13X penetrating the high reflection coating 14 exhibited a response speed equivalent to that of the liquid crystal display device 1000 without a dielectric film.

As described above, the liquid crystal display device 1 of the present embodiment makes it possible to amplify the phase modulation amount and improve the response speed while improving the reflectance.

Next, Modification Examples 1 to 5 of the present disclosure will be described. Note that components similar to those of the liquid crystal display device 1 in the above-described embodiment are denoted by the same reference numerals, and description thereof is omitted as appropriate.

### 2. MODIFICATION EXAMPLES

### 2-1. Modification Example 1

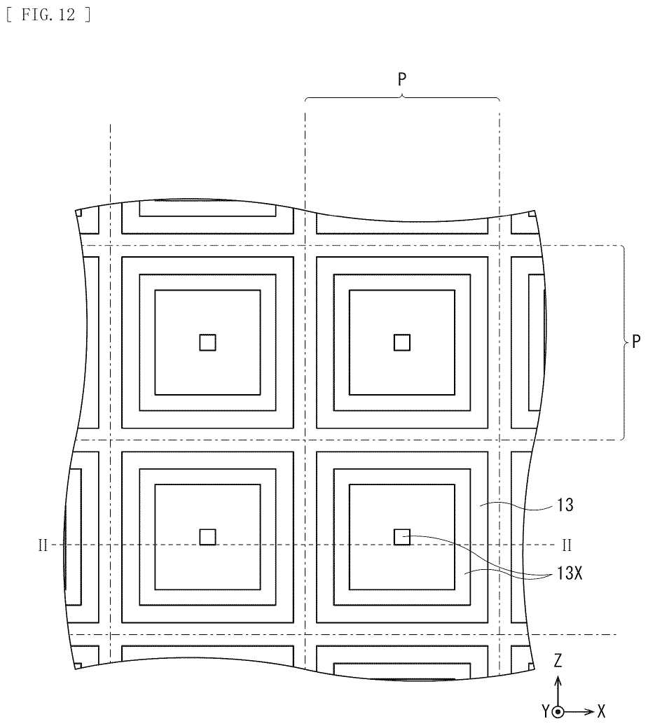

FIG. 11 illustrates an example of a schematic cross-sectional configuration of a liquid crystal display device (liquid crystal display device 1A) according to Modification Example 1 of the present disclosure. FIG. 12 schematically illustrates an example of a planar configuration of the multiple pixel electrodes 13 of the liquid crystal display device 1A illustrated in FIG. 11. FIG. 11 illustrates a cross section corresponding to a line II-II illustrated in FIG. 12.

The liquid crystal display device 1A differs from the above-described embodiment in that the standing part 13X provided on each of the multiple pixel electrodes 13 and standing toward the liquid crystal layer 30 includes a partition structure continuously formed along the outer shape of the pixel electrode 13 and a columnar structure provided inside the partition structure.

Thus, the liquid crystal display device 1A of the present modification example improves flatness of an electric field distribution to be applied to the liquid crystal layer 30, as compared with the liquid crystal display device 1 of the above-described embodiment. This reduces unnecessary diffracted light caused by a spatial distribution of the rotational angle of the liquid crystal molecule. This makes it possible to improve the light utilization efficiency, in addition to the effects of the above-described embodiment.

### 2-2. Modification Example 2

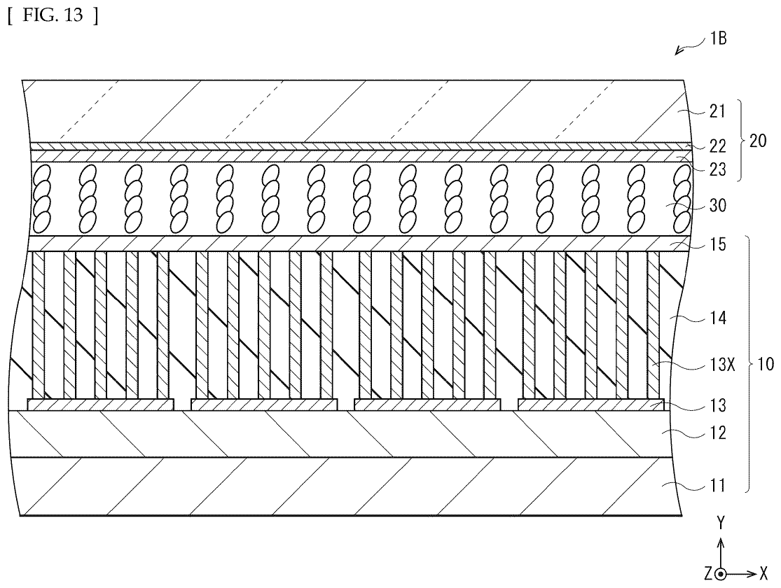

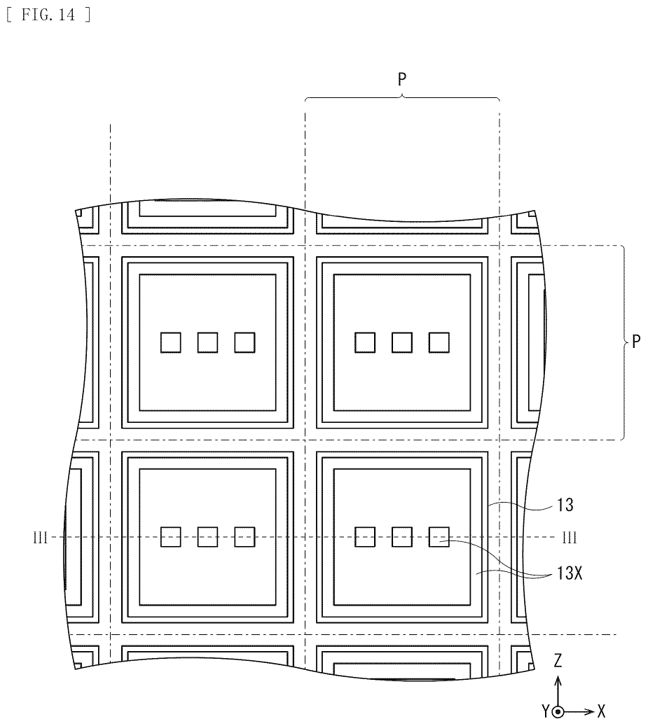

FIG. 13 illustrates an example of a schematic cross-sectional configuration of a liquid crystal display device (liquid crystal display device 1B) according to Modification Example 2 of the present disclosure. FIG. 14 schematically illustrates an example of a planar configuration of the multiple pixel electrodes 13 of the liquid crystal display device 1B illustrated in FIG. 13. FIG. 13 illustrates a cross section corresponding to a line III-III illustrated in FIG. 14. Modification Example 1 described above is an example in which one columnar structure is provided inside the partition structure as the standing part 13X, but the present disclosure is not limited thereto.

The liquid crystal display device 1B includes, as the standing part 13X provided on each of the multiple pixel electrodes 13 and standing toward the liquid crystal layer 30, a partition structure continuously formed along the outer shape of the pixel electrode 13 and multiple (three in this case) columnar structures provided inside the partition structure.

Thus, the liquid crystal display device 1B of the present modification example further improves the flatness of the electric field distribution to be applied to the liquid crystal layer 30 and further reduces the unnecessary diffracted light caused by the spatial distribution of the rotational angle of the liquid crystal molecule, as compared with the liquid crystal display device 1A of Modification Example 1 described above. This makes it possible to further improve the light utilization efficiency, in addition to the effects of the above-described embodiment.

Note that the present modification example describes an example in which the multiple columnar structures are provided side-by-side in one direction (e.g., an X-axis direction), but the present disclosure is not limited thereto. For example, the multiple columnar structures may be provided evenly in the X-axis direction and a Y-axis direction inside the partition structure.

### 2-3. Modification Example 3

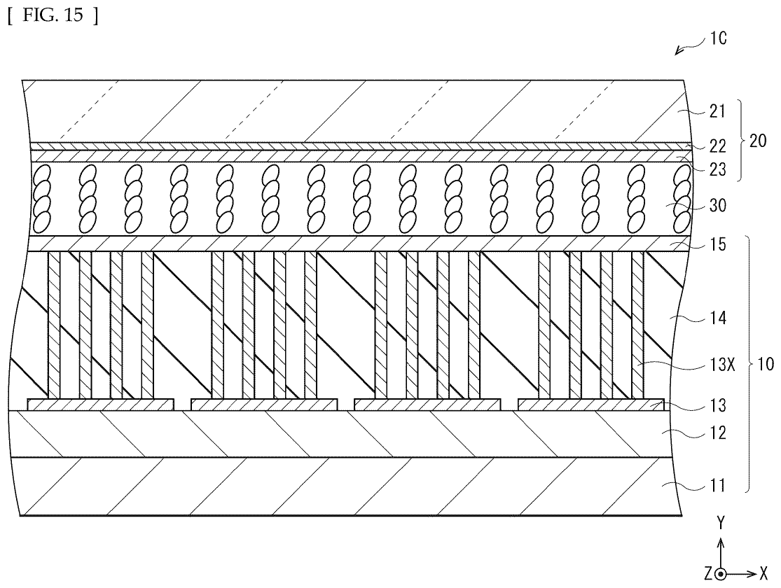

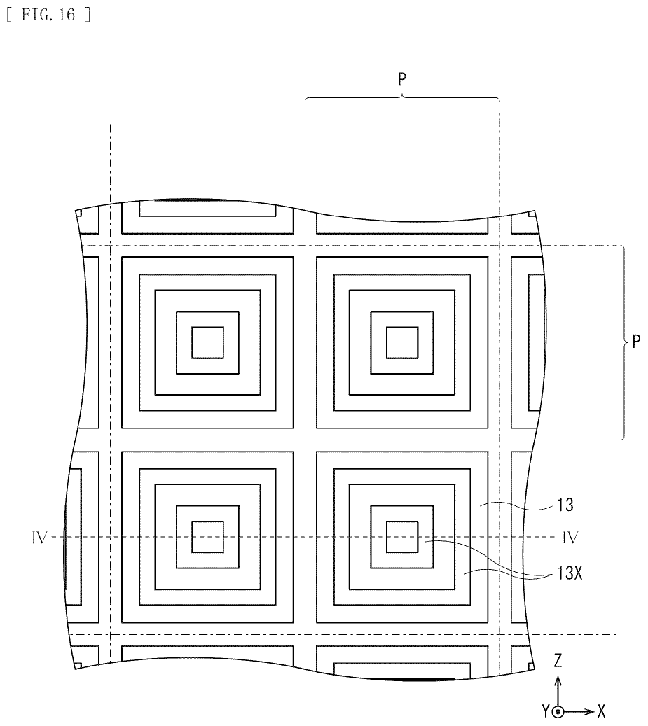

FIG. 15 illustrates an example of a schematic cross-sectional configuration of a liquid crystal display device (liquid crystal display device 1C) according to Modification Example 3 of the present disclosure. FIG. 16 schematically illustrates an example of a planar configuration of the multiple pixel electrodes 13 of the liquid crystal display device 1C illustrated in FIG. 15. FIG. 15 illustrates a cross section corresponding to a line IV-IV illustrated in FIG. 16. Modification Examples 1 and 2 described above are examples in which one or more columnar structures are provided inside the partition structure as the standing part 13X, but the present disclosure is not limited thereto.

The liquid crystal display device 1C differs from the above-described embodiment in that a multi-partition structure continuously formed along the outer shape of the pixel electrode 13 is provided, as the standing part 13X provided on each of the multiple pixel electrodes 13 and standing toward the liquid crystal layer 30.

Thus, the liquid crystal display device 1C of the present modification example further improves the flatness of the electric field distribution to be applied to the liquid crystal layer 30 and further reduces the unnecessary diffracted light caused by the spatial distribution of the rotational angle of the liquid crystal molecule, as compared with the liquid crystal display devices 1A and 1B of Modification Example 1 described above. This makes it possible to further improve the light utilization efficiency, in addition to the effects of the above-described embodiment.

### 2-4. Modification Example 4

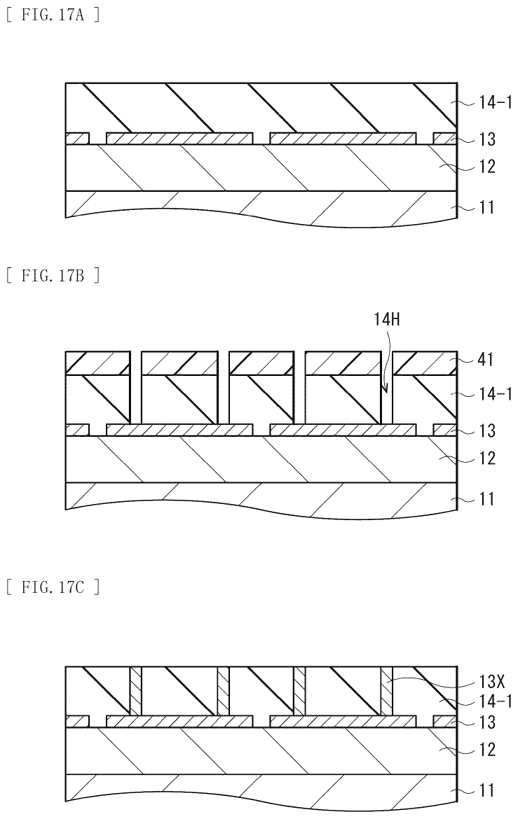

FIGS. 17A to 17E schematically illustrate an example of a method of manufacturing the pixel electrode 13 of the liquid crystal display device 1 according to Modification Example 4 of the present disclosure. The pixel electrode 13 of the liquid crystal display device 1 of the above-described embodiment may be formed by the following method.

First, as illustrated in FIG. 17A, the multiple pixel electrodes 13 are formed for the respective pixels P on the pixel circuit layer 12 in a manner similar to that in the above-described embodiment, and thereafter the low refractive index film and the high refractive index film are formed alternately by, for example, a vapor deposition method to form a dielectric multilayer film 14-1, as a portion of the high reflection coating 14. Next, as illustrated in FIG. 17B, the resist film 41 is formed in a pattern on the dielectric multilayer film 14-1 by a lithography technique, and thereafter the opening 14H is formed to penetrate the dielectric multilayer film 14-1 to the pixel electrode 13 by dry processing.

Subsequently, as illustrated in FIG. 17C, an electrically-conductive film is embedded in the opening 14H by, for example, a CVD method or an ALD method, and thereafter the electrically-conductive film formed on the dielectric multilayer film 14-1 is removed by, for example, CMP to form a standing part 13X-1. Next, as illustrated in FIG. 17D, a dielectric multilayer film 14-2 is further formed on the dielectric multilayer film 14-1 and thereafter a standing part 13X-2 (not illustrated) is formed by a similar method.

By repeating this n times, as illustrated in FIG. 17E, the standing part 13X standing toward the liquid crystal layer 30 and penetrating the high reflection coating 14 is formed on each of the multiple pixel electrodes 13. The alignment film 15 is thereafter formed on the high reflection coating 14 by, for example, a CVD method. Thus, the drive substrate 10 is completed.

### 2-5. Modification Example 5

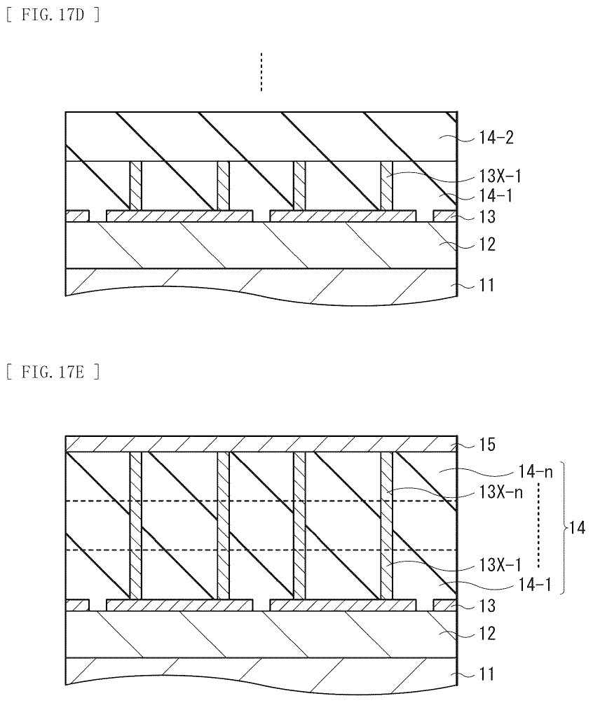

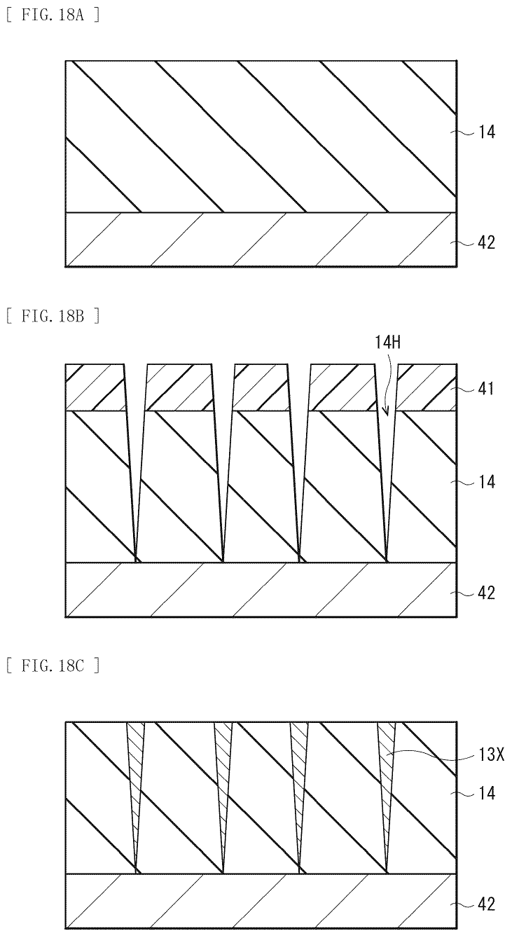

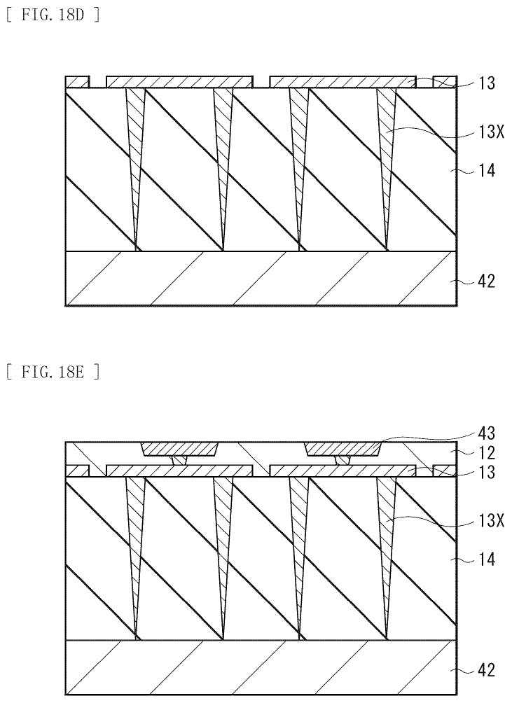

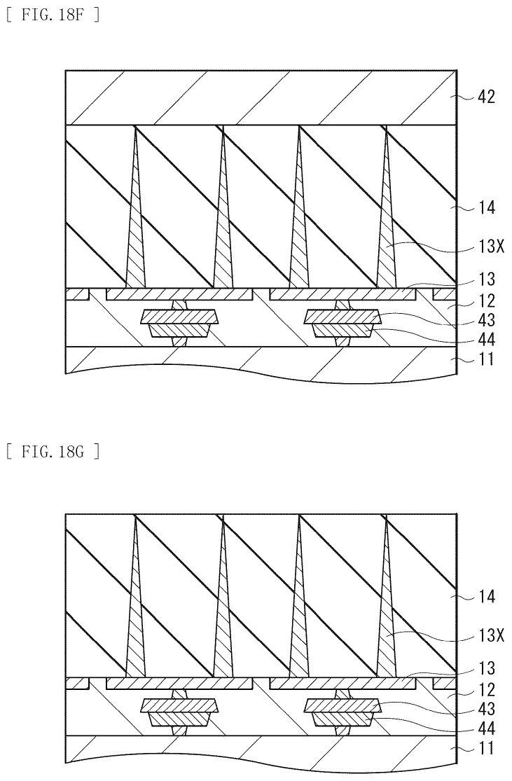

FIG. 18A to FIG. 18G schematically illustrate an example of a method of manufacturing the pixel electrode 13 of the liquid crystal display device 1 according to Modification Example 5 of the present disclosure. The pixel electrode 13 of the liquid crystal display device 1 of the above-described embodiment may be formed by the following method.

First, as illustrated in FIG. 18A, the low refractive index film and the high refractive index film are formed alternately on a support substrate 42 by, for example, a vapor deposition method to form the high reflection coating 14 including the dielectric multilayer film. Next, as illustrated in FIG. 18B, the resist film 41 is formed in a pattern on the high reflection coating 14 by a lithography technique, and thereafter the opening 14H is formed to penetrate the high reflection coating 14 to the support substrate 42 by dry processing.

Subsequently, as illustrated in FIG. 18C, an electrically-conductive film is embedded in the opening 14H by, for example, a CVD method or an ALD method, and thereafter the electrically-conductive film formed on the high reflection coating 14 is removed by, for example, CMP to form the standing part 13X. Next, as illustrated in FIG. 18D, a metal film is formed by, for example, a CVD method, and is thereafter processed by a lithography technique and dry processing (or wet processing) to form the multiple pixel electrodes 13 for the respective pixels P.

Subsequently, as illustrated in FIG. 18E, the pixel circuit layer 12 including a pad part 43 is formed. Next, as illustrated in FIG. 18F, the pad part 43 that is exposed on the surface of the pixel circuit layer 12 on the support substrate 42 inverted, and a pad part 44 that is exposed on the surface of the pixel circuit layer 12 provided on the substrate 11 separately formed are bonded to each other. The support substrate 42 is thereafter removed, as illustrated in FIG. 18G. Thus, the drive substrate 10 is completed.

### 3. APPLICATION EXAMPLES

The liquid crystal display device 1 of the present disclosure is applicable to various display apparatuses of a type that modulates light from a light source through the liquid crystal display device 1 and displays an image. For example, the display apparatus of the present disclosure may be applied to a head-up display, Augmented Reality (AR) glasses, etc. In addition, the display apparatus of the present disclosure may be applied to an optical sensing technique such as LiDAR by generating any phase distribution to deflect a light beam.

It is to be noted that the effects described in the specification are mere examples. The effects are not limited to the effects described in the specification. There may be any other effects than those described herein.

The present technology may also have the following configurations. According to the present technology having the following configurations, the one or more standing parts standing toward the liquid crystal layer are provided on each of the multiple first electrodes that are provided for the respective pixels and to each of which the predetermined voltage is applied by the pixel circuit that drives the liquid crystal layer for each of the pixels. This increases the effective potential to be applied to the liquid crystal layer. This makes it possible to amplify the phase modulation amount and improve the response speed while improving the reflectance.

(1)

A liquid crystal display device including:
a liquid crystal layer;
a first substrate including a pixel circuit that drives the liquid crystal layer for each of pixels;
a second substrate disposed to be opposed to the first substrate with the liquid crystal layer interposed therebetween; and
multiple first electrodes that are provided on the first substrate for the respective pixels and each include one or more standing parts standing toward the liquid crystal layer, a predetermined voltage being applied to each of the multiple first electrodes by the pixel circuit.
   (2)

The liquid crystal display device according to (1), in which the first electrode includes a partition structure continuously formed along an outer shape of the first electrode, as the one or more standing parts.

(3)

The liquid crystal display device according to (2), in which the first electrode includes one or more columnar structures inside the partition structure, as the one or more standing parts.

(4)

The liquid crystal display device according to any one of (1) to (3), in which the first electrode includes a multi-partition structure continuously formed along an outer shape of the first electrode, as the one or more standing parts.

(5)

The liquid crystal display device according to any one of (1) to (4), in which
the first substrate further includes a dielectric film including one or more layers disposed between the multiple first electrodes and the liquid crystal layer, and
the one or more standing parts provided on each of the multiple first electrodes extend toward the liquid crystal layer in the dielectric film including the one or more layers.
   (6)

The liquid crystal display device according to (4) or (5), in which the one or more standing parts penetrate the dielectric film including the one or more layers.

(7)

The liquid crystal display device according to any one of (1) to (6), in which the one or more standing parts include an electrically-conductive material.

(8)

The liquid crystal display device according to (7), in which the electrically-conductive material includes a metal having a light-reflecting property with respect to visible light.

(9)

The liquid crystal display device according to any one of (1) to (8), in which the one or more standing parts include aluminum (Al), copper (Cu), gold (Au), silver (Ag), or tungsten (W).

(10)

The liquid crystal display device according to (7), in which the electrically-conductive material has a light-transmitting property.

(11)

The liquid crystal display device according to any one of (1) to (7) and (10), in which the one or more standing parts include indium tin oxide (ITO), indium zinc oxide (IZO), or tin oxide (SnO₂).

(12)

The liquid crystal display device according to any one of (5) to (11), in which the first substrate and the second substrate each further include an alignment film on a surface side opposed to the liquid crystal layer.

(13)

The liquid crystal display device according to (12), in which the alignment film on the first substrate is provided on the dielectric film including the one or more layers.

(14)

The liquid crystal display device according to (12) or (13), in which
the second substrate further includes a second electrode common to the multiple pixels, and
the alignment film on the second substrate is provided on the second electrode.
   (15)

A display apparatus provided with a liquid crystal display device, the liquid crystal display device including:
a liquid crystal layer;
a first substrate including a pixel circuit that drives the liquid crystal layer for each of pixels;
a second substrate disposed to be opposed to the first substrate with the liquid crystal layer interposed therebetween; and
multiple first electrodes that are provided on the first substrate for the respective pixels and each include one or more standing parts standing toward the liquid crystal layer, a predetermined voltage being applied to each of the multiple first electrodes by the pixel circuit.
   (16)

The display apparatus according to (15), further including a correction system that flattens a phase difference distribution in a display region.

(17)

The display apparatus according to (15) or (16), further including, on a light emission side, a diffraction device that removes unnecessary diffracted light included in emitted light that is emitted from the liquid crystal display device.

This application claims the benefit of Japanese Priority Patent Application JP2022-096656 filed with the Japan Patent Office on Jun. 15, 2022, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A liquid crystal display device comprising:
a liquid crystal layer;
a first substrate including a pixel circuit that drives the liquid crystal layer for each of pixels;
a second substrate disposed to be opposed to the first substrate with the liquid crystal layer interposed therebetween; and
multiple first electrodes that are provided on the first substrate for the respective pixels and each include one or more standing parts standing toward the liquid crystal layer, a predetermined voltage being applied to each of the multiple first electrodes by the pixel circuit.

2. The liquid crystal display device according to claim 1, wherein the first electrode includes a partition structure continuously formed along an outer shape of the first electrode, as the one or more standing parts.

3. The liquid crystal display device according to claim 2, wherein the first electrode includes one or more columnar structures inside the partition structure, as the one or more standing parts.

4. The liquid crystal display device according to claim 1, wherein the first electrode includes a multi-partition structure continuously formed along an outer shape of the first electrode, as the one or more standing parts.

5. The liquid crystal display device according to claim 1, wherein
the first substrate further includes a dielectric film including one or more layers disposed between the multiple first electrodes and the liquid crystal layer, and
the one or more standing parts provided on each of the multiple first electrodes extend toward the liquid crystal layer in the dielectric film including the one or more layers.

6. The liquid crystal display device according to claim 4, wherein the one or more standing parts penetrate the dielectric film including the one or more layers.

7. The liquid crystal display device according to claim 1, wherein the one or more standing parts include an electrically-conductive material.

8. The liquid crystal display device according to claim 7, wherein the electrically-conductive material comprises a metal having a light-reflecting property with respect to visible light.

9. The liquid crystal display device according to claim 1, wherein the one or more standing parts include aluminum (Al), copper (Cu), gold (Au), silver (Ag), or tungsten (W).

10. The liquid crystal display device according to claim 7, wherein the electrically-conductive material has a light-transmitting property.

11. The liquid crystal display device according to claim 1, wherein the one or more standing parts include indium tin oxide (ITO), indium zinc oxide (IZO), or tin oxide (SnO₂).

12. The liquid crystal display device according to claim 5, wherein the first substrate and the second substrate each further include an alignment film on a surface side opposed to the liquid crystal layer.

13. The liquid crystal display device according to claim 12, wherein the alignment film on the first substrate is provided on the dielectric film including the one or more layers.

14. The liquid crystal display device according to claim 12, wherein
the second substrate further includes a second electrode common to the multiple pixels, and
the alignment film on the second substrate is provided on the second electrode.

15. A display apparatus provided with a liquid crystal display device, the liquid crystal display device comprising:
a liquid crystal layer;
a first substrate including a pixel circuit that drives the liquid crystal layer for each of pixels;
a second substrate disposed to be opposed to the first substrate with the liquid crystal layer interposed therebetween; and
multiple first electrodes that are provided on the first substrate for the respective pixels and each include one or more standing parts standing toward the liquid crystal layer, a predetermined voltage being applied to each of the multiple first electrodes by the pixel circuit.

16. The display apparatus according to claim 15, further comprising a correction system that flattens a phase difference distribution in a display region.

17. The display apparatus according to claim 15, further comprising, on a light emission side, a diffraction device that removes unnecessary diffracted light included in emitted light that is emitted from the liquid crystal display device.
